(19) United States
(12) Patent Application Publication
(10) Pub. No.: US 2007/0220707 A1
(43) Pub. Date: Sep. 27, 2007

(54) Hinge

(76) Inventor: Lee Hoong Thye Eldon, Singapore (SG)

Correspondence Address: INTELLECTUAL PROPERTY LAW GROUP LLP, 12 SOUTH FIRST STREET, SUITE 1205, SAN JOSE, CA, 95113, US

(21) Appl. No.: 11/573,354

(22) PCT Filed: Aug. 6, 2004
(86) PCT No.: PCT/SG04/00238

§ 371 Date: Feb. 6, 2007

(51) Int. Cl. E05D 7/00

(52) U.S. Cl. 16/221

(57) ABSTRACT

A hinge having two bases (2A/2B) on which a plurality of hollow cylinders (8) are arranged axially and spaced along each of the bases. Fixer holes (12) are provided in the bases at the spaces (10) between the cylinders to enable the hinge to be mounted directly without the need to work the mounting surface. The bases may be constructed to conceal the mounting screws (18).

### 1. BACKGROUND OF INVENTION

The present invention relates to hinges for use generally on doors.

Traditionally butt hinges are constructed using a central pin from which two flanges extend. These hinges need to be chiseled and mortised into timber doors or recessed into metal doors with reinforcement plates. If this is fabricated in a factory, as they usually are, the hinges face the problems of alignment, trimming, cutting doors, relative hinge positions changed, etc, due to differences in floor to ceiling heights depending on location and premises.

The alternative is to customize the hinges on site but due to current hinge designs, much carpentry and metalworking is required to install the hinges into the door. This is one of the main reasons for the excessive amount of time and effort currently required to install door hinges and to mount the door to its frame.

This does not obviate the parts of the hinge from being observable on the edge of the door leaf and frame respectively.

### 2. SUMMARY OF INVENTION

It is an object of this invention to provide a hinge capable of being installed so that a door may be mounted to its frame with less time and effort.

The invention is a hinge comprising:
a. two bases;
b. a plurality of hollow cylinders are arranged axially and spaced along each of the bases;
c. a plurality of fixer holes located on each of the bases in the spaces between the cylinders
   whereby when the bases are mounted co-axially adjacent to each other the hollow cylinders on one base fits into the spaces between the cylinders in the other base.

### 3. BRIEF DESCRIPTION OF DRAWINGS

An example of the method in this invention will now be described by reference to the following drawings.

FIG. 1 is a perspective view of a preferred embodiment of a hinge secured on a door and frame in accordance with the invention.

FIG. 2 is a side view of two parts of the hinge.

FIG. 3 is a side view of the hinge mortised into a door and frame.

FIG. 4 is a side view of a variation of the hinge mortised into a door and frame.

FIG. 5 is a cross-sectional view of a mounted base of the hinge without the cylinder.

FIG. 6 is side views of various possible shapes of the linge.

### 4. DESCRIPTION OF THE PREFERRED EMBODIMENTS

The objective of the invention is to allow the hinge to be secured to a door and frame directly without the need to chisel or shape the door or frame to create a recess to accommodate the flanges of the hinge.

In one preferred embodiment, the hinge comprises a base 2A preferably constructed with a concave surface 6 to receive a quadrant of a hollow cylinder 8 so that the latter sits snugly in the concave surface of the base. A plurality of hollow cylinders are fixed and spaced along the base. For the ease of manufacture, the space 10 should preferably be of equal dimension.

A fixer hole 12 is machined into the concave surface of the base where the space 10 is located. The hinge would be secured to a door or frame through these fixer holes.

The hinge comprises another counterpart base 2B of a similar configuration. The hinge is completed by both bases meeting by fitting the cylinders 8 on one base 2A into the space 10 of the other base 2B.

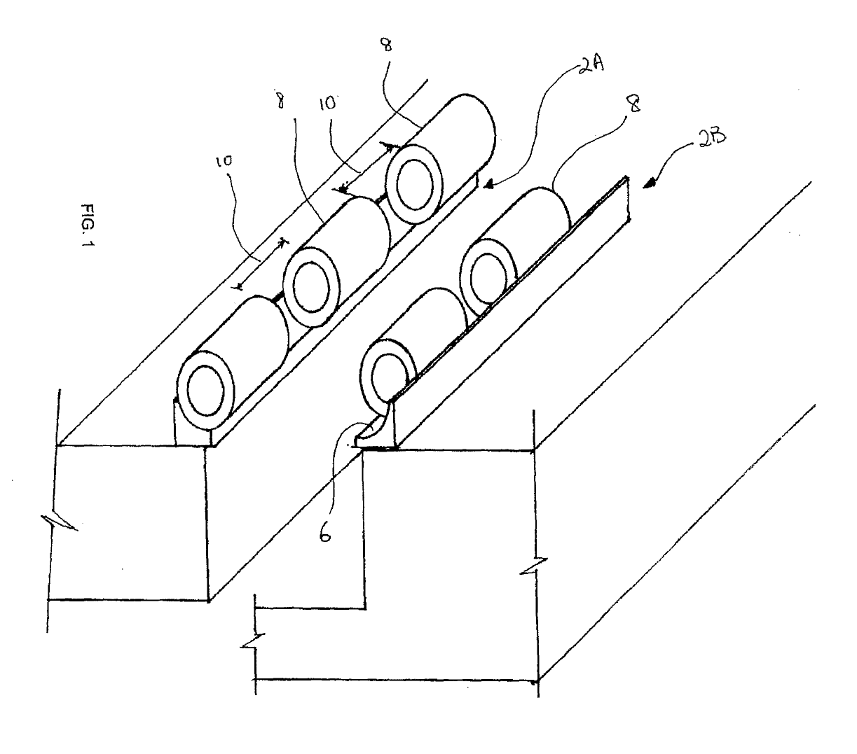

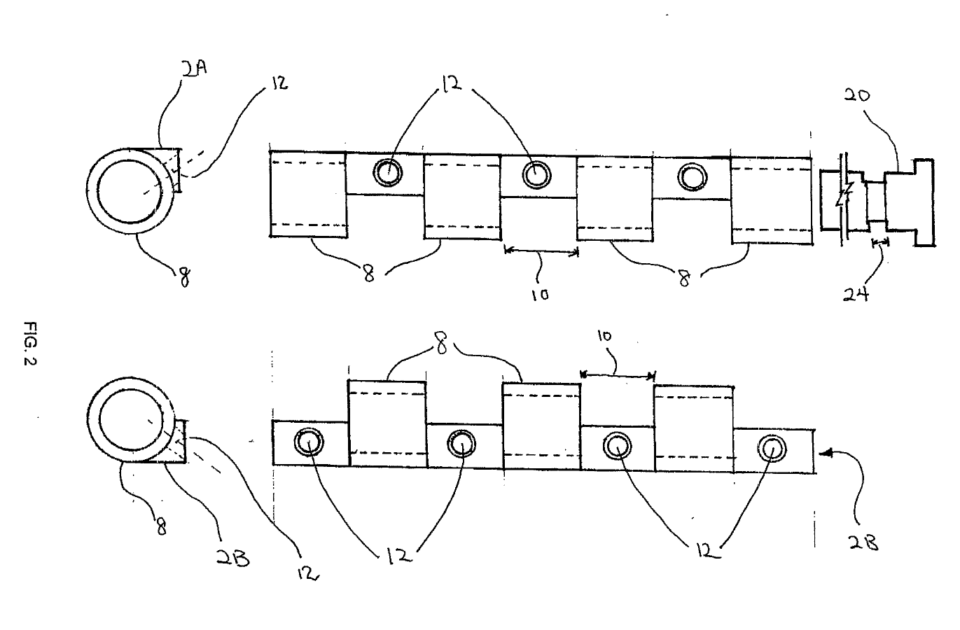

To install the hinge, one base 2A is mounted on a door leaf surface 14 while the other base 2B is mounted on a frame 16 by means of mounting screws 18 through the fixer hole 12. The bases are mounted close enough to each other so that the cylinders 8 on both bases are aligned into a straight row when the cylinders on one base fit into the spaces 10 on the other. Once aligned, they are held in place with a pin 20 dropped through the cylinders and secured, See FIG. 1 and FIG. 2.

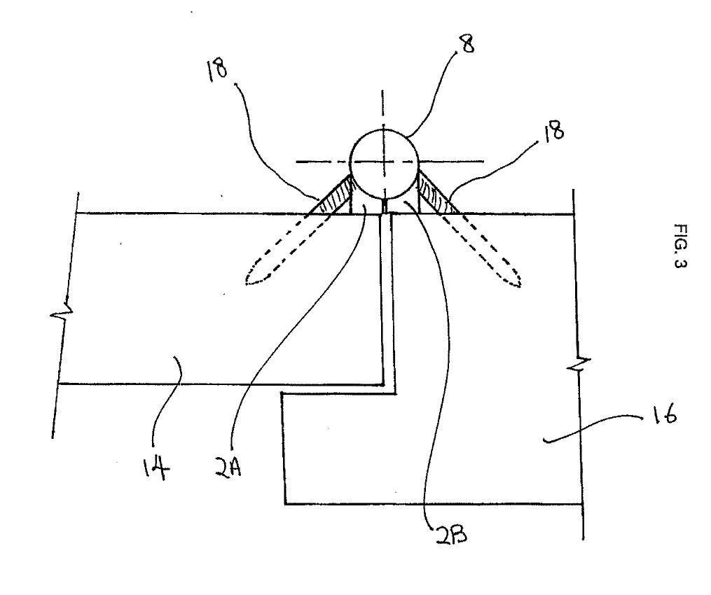

The mounting screw 18 used to secure the hinge should preferably have a deep thread and short shank. It can be directly screwed through the base using it as a template. The mounting screw will penetrate the door and frame (the mounting surface) at an angle to give better stability and not let in perpendicular to the mounting surface. In this embodiment, the mounting screw, because of its angular penetration into the mounting surface, is visible between the mounting surface and the cylinder 8. See FIG. 3.

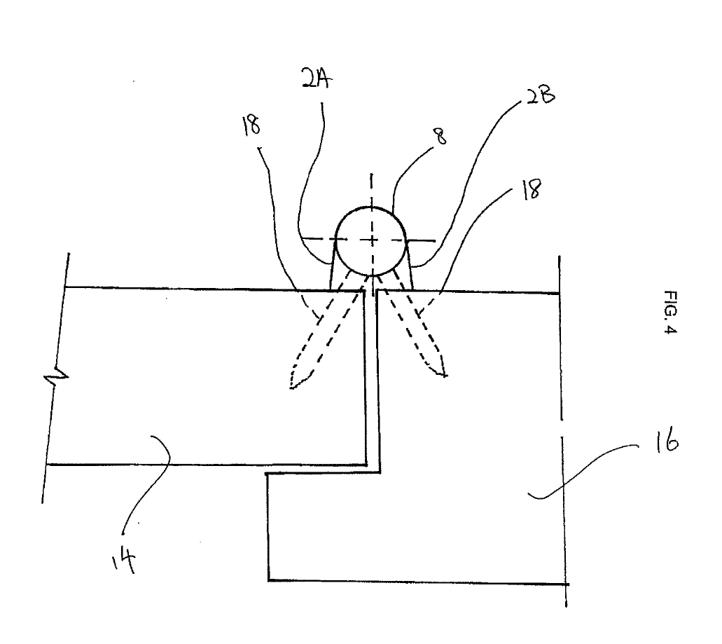

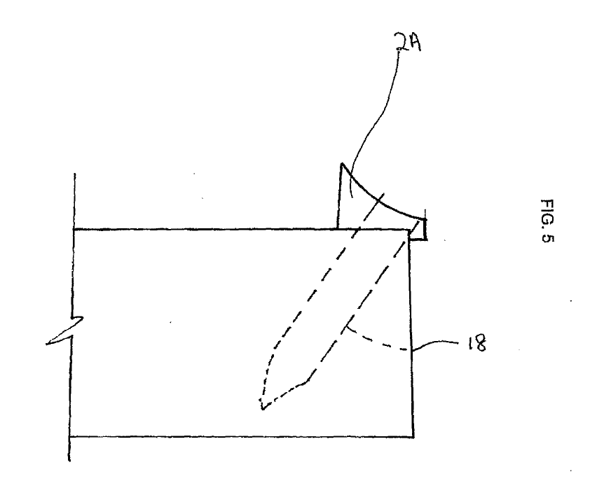

This unsightly feature may be overcome by making the base 2A/2B wider at the mounting surface so as to completely conceal the mounting screw. See FIG. 4 Where the hinge has to be made more robust for heavy doors, a small rebate 22 on the base can be used to hug the edge of the mounting surfaces 14 and 16 respectively leaving a 3 mm gap (which is the industry standard) in between. See FIG. 5.

This is to allow the mounting screw 18 to be placed nearer to the edge without being visible when the door is open. In this way the mounting screw may be of a larger diameter to carry heavier load and still not be visible. This type of mounting screw is not self-tapping and requires pre-drilling. Pre-drilling can be done directly through the base 2A and 2B or with a template.

In another preferred embodiment, the hinge cylinder 8 can be shorter in length so that when assembled, gaps are visible in between. These gaps are for inserting washers or ball bearings so as to allow for smoother turning and carrying heavier load.

In another preferred embodiment, to prevent unauthorized removal of the pin 20, the pin may have a groove 24 encircling a circumference of its shank through which a safety screw may be inserted to hold the pin in place. Any attempt to remove the pin would be obstructed by the safety screw. A suitable hole may be made through a cylinder 8 in order for the safety screw to pass through. The safety screw is inserted into the hinge when the door is open and hence accessible only when the door is open. See FIG. 2.

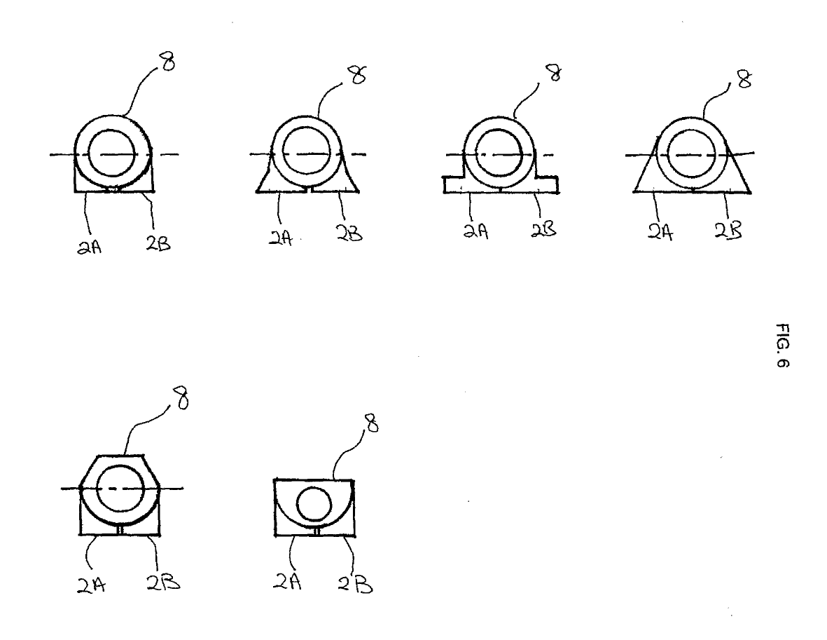

In another preferred embodiments, both the bases and cylinders 8 may take on various shapes. See FIG. 6.

1. A hinge comprises the following:
a. two bases;
b. a plurality of hollow cylinders are arranged axially and spaced along each of the bases;
c. a plurality of fixer holes located on each of the bases in the spaces between the cylinders
whereby when the bases are mounted co-axially adjacent to each other the hollow cylinders on one base fits into the spaces between the cylinders in the other base.

2. The hinge, according to claim 1, wherein the bases are shaped so as to conceal mounting screws in the fixer holes.

3. A hinge substantially as hereinbefore described with reference to the accompanying drawings.
